(19) United States
(12) Patent Application Publication
(10) Pub. No.: US 2024/0313565 A1
(43) Pub. Date: Sep. 19, 2024

(54) ELECTRIC POWER SYSTEM, ELECTRONIC DEVICE, ELECTRIC POWER CONTROL METHOD, AND NON-TRANSITORY COMPUTER READABLE MEDIUM

(71) Applicant: KABUSHIKI KAISHA TOSHIBA, Tokyo (JP)

(72) Inventor: Tetsu SHIJO, Setagaya Tokyo (JP)

(73) Assignee: KABUSHIKI KAISHA TOSHIBA, Tokyo (JP)

(21) Appl. No.: 18/513,947

(22) Filed: Nov. 20, 2023

(30) Foreign Application Priority Data
Mar. 16, 2023 (JP) 2023-042396

(51) Int. Cl. H02J 7/00; H02J 3/32

(52) U.S. Cl. CPC H02J 7/00712; H02J 3/32; H02J 7/00032; H02J 7/0048

(57) ABSTRACT

According to one embodiment, an electric power system includes an electrical storage device electrically connected to an electric power system; and a controller configured to control the electrical storage device based on an electric power command from an upper control system configured to control input-output electric power of the electrical storage device, and make a transition to an autonomous mode in which the input-output electric power of the electrical storage device is controlled based on a charge remaining amount of the electrical storage device, in at least one of a case where the controller senses that communication with the upper control system fails or a case where the controller senses that the electrical storage device and the electric power system is disconnected.

### CROSS REFERENCE TO RELATED APPLICATIONS

This application is based upon and claims the benefit of priority from the prior Japanese Patent Application No. 2023-042396, filed on Mar. 16, 2023, the entire contents of which are incorporated herein by reference.

### FIELD

An embodiment of the present invention relates to an electric power system, an electronic device, an electric power control method, and a non-transitory computer readable medium.

### BACKGROUND

A partial system (microgrid) connected to an electric power system controls the value of electric power that is output (discharged) from or input (charged) to a storage battery (secondary battery) in the microgrid in accordance with a command from an upper control system that provides supply-demand balancing services (control reserve) of electric power in the microgrid.

For some reason, communication failure occurs between the upper control system and the microgrid, and/or electric power connection to the electric power system is broken e in some cases. In such a case, the microgrid itself needs to control the storage battery independently from the upper control system.

For example, when the storage battery continues operation in accordance with a command received last from the upper control system before the communication failure, the storage battery eventually approaches or reaches a fully charged state (SoC=100%) or a completely discharged state (SoC=0%). The storage battery potentially fails with further attempt to charge in the fully charged state or further attempt to discharge in the completely discharged state, and thus the storage battery needs to be maintained in a state that is not the fully charged state nor the completely discharged state. Furthermore, for example, even when the communication failure is resolved after the storage battery becomes the completely discharged state, the microgrid potentially may not recover because of insufficient electric power for actuating a control device in the microgrid.

### BRIEF DESCRIPTION OF THE DRAWINGS

FIG. 1 is a block diagram illustrating an electric power system according to an embodiment;

FIG. 2 is a diagram illustrating an example of controlled SoC behavior of a storage battery at charging;

FIG. 3 is a diagram illustrating an example of controlled SoC behavior of the storage battery at discharging;

FIG. 4 is a flowchart illustrating an exemplary operation performed by an inverter;

FIG. 5 is a diagram illustrating an example of droop characteristics of a microgrid;

FIG. 6 is a diagram illustrating another example of controlled SoC behavior of the storage battery at charging;

FIG. 7 is a diagram illustrating still another example of controlled SoC behavior of the storage battery at charging;

FIG. 8 is a diagram illustrating another example of controlled SoC behavior of the storage battery at discharging;

FIG. 9 is a diagram illustrating still another example of controlled SoC behavior of the storage battery at discharging; and

FIG. 10 is a block diagram illustrating an example of a hardware configuration in the embodiment.

### DETAILED DESCRIPTION

According to one embodiment, an electric power system includes an electrical storage device electrically connected to an electric power system; and a controller configured to control the electrical storage device based on an electric power command from an upper control system configured to control input-output electric power of the electrical storage device, and make a transition to an autonomous mode in which the input-output electric power of the electrical storage device is controlled based on a charge remaining amount of the electrical storage device, in at least one of a case where the controller senses that communication with the upper control system fails or a case where the controller senses that the electrical storage device and the electric power system is disconnected.

An embodiment of the present invention will be described below with reference to the accompanying drawings.

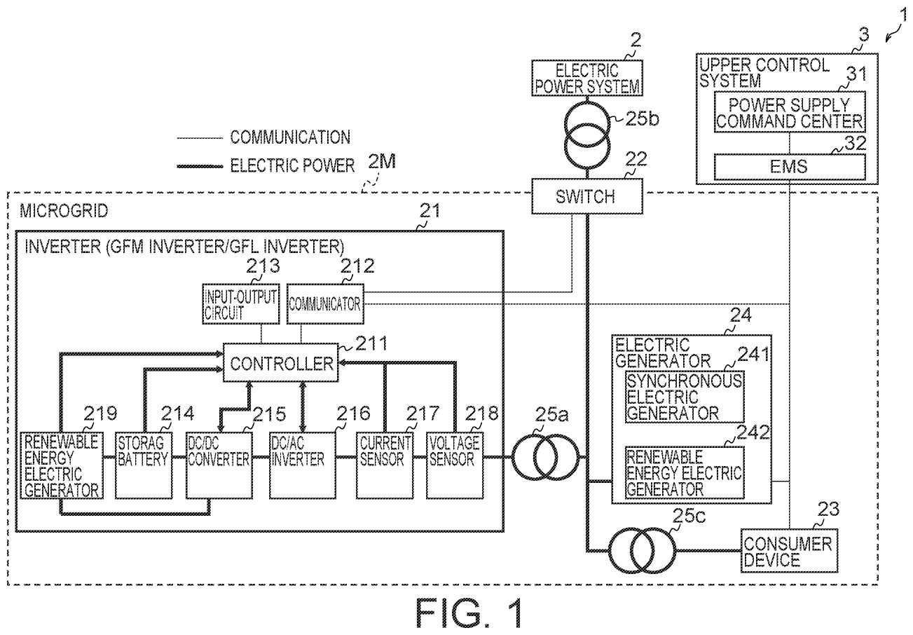

FIG. 1 is a block diagram illustrating an example of the entire configuration of an electric power system 1 according to an embodiment of the present invention. Thick lines represent electric power connection, and thin lines represent communication connection.

An electric power system 2 is a system for distributing electric power to a consumer device 23. The electric power system 2 is connected to a microgrid 2M through a switch 22. The electric power system 2 has optional scale and kind.

In the electric power system 2, a partial system in which an inverter 21, a synchronous electric generator 241, and the consumer device 23 are connected is the microgrid 2M. In other words, the microgrid 2M is part of the electric power system 2.

The microgrid 2M receives a command from an upper control system 3 and performs electric power control of the microgrid 2M based on the command. The command is, for example, an electric power command value P_{command} that designates the value (electric power value P) of electric power input to a storage battery 214 or output from the storage battery 214. The command may include, for example, a frequency command value or a voltage command value. Hereinafter, the electric power value P and the electric power command value P_{command} are assumed to be active power values but may include reactive power values.

The upper control system 3 has a structure of a plurality of layers and includes, for example, a power supply command center 31 and an energy management system (EMS) 32. The power supply command center 31 is a highest-level control system. The EMS 32 receives a command from the power supply command center 31 and controls the inverter 21 through a communicator 212. Another EMS at a lower level than the EMS 32 may be provided in the microgrid 2M.

When anomaly such as an accident has occurred to the electric power system 2 or when work is performed, the switch 22 is opened (OFF) to cut off power transmission between the electric power system 2 and the inverter 21. In a normal situation, for example, when no anomaly has occurred to the electric power system 2, the switch 22 is closed (ON).

The consumer device 23 is a load device that consumes electric power at a house, a school, a factory, a business operator, or the like. The consumer device 23 may include an electrical storage device configured to store surplus electric power in the electric power system 2. A plurality of consumer devices 23 may exist.

An electric generator 24 supplies electric power to the electric power system 2 or the microgrid 2M. The electric generator 24 includes the synchronous electric generator 241 and/or a renewable energy electric generator 242.

The synchronous electric generator 241 generates AC power. A plurality of synchronous electric generators 241 may exist. The synchronous electric generator 241 includes an emergency electric generator and/or a normal electric generator. The emergency electric generator is, for example, an emergency diesel electric generator.

The emergency electric generator does not operate in a normal situation, but starts operating based on an instruction from a worker when the microgrid 2M is disconnected from the electric power system 2. The worker may provide an instruction by using a switch such as a button provided at the synchronous electric generator 241 or may provide an instruction by using a usable terminal through wireless or wired communication.

The renewable energy electric generator 242 generates variable renewable energy. The renewable energy electric generator 242 is, for example, a solar power generator. When the renewable energy electric generator 242 is a solar power generator, the renewable energy electric generator 242 may include a converter configured to convert output electric power from DC power into AC power.

The inverter 21 is an electronic device for supplying electric power charged in the storage battery 214 to the consumer device 23. Electric power output from the inverter 21 is converted into appropriate voltage through, for example, a transformer 25a and a transformer 25c and supplied to the consumer device 23. Alternatively, electric power output from the inverter 21 may be transmitted to the electric power system 2 through the transformer 25a and a transformer 25b (reverse power flow). The inverter 21 is called an electric power conversion device or a power conditioning system (PCS).

The inverter 21 is connected to the microgrid 2M through the transformer 25a. The inverter 21 functions as a grid following inverter that controls electric power supplied from a storage battery as current output to the microgrid 2M, or a grid forming inverter that controls the electric power as voltage output to the microgrid 2M. The inverter 21 may switch the state of the inverter 21 to the grid forming inverter or the grid following inverter by a controller 211.

The inverter 21 includes the controller 211, the communicator 212, an inputter-outputter 213, the storage battery (electrical storage device or rechargeable battery) 214, a DC/DC converter 215, a DC/AC inverter 216, a current sensor 217, a voltage sensor 218, and a renewable energy electric generator 219.

At least some of the elements 211 to 219 may be configured as a circuit or processor such as a micro controller, an application specific integrated circuit (ASIC), or a field-programmable gate array (FPGA). Alternatively, some or all of these elements may be executed by a CPU that executes a computer program.

The controller 211 controls the inverter 21. Operation of the controller 211 will be described in detail in exemplary operations to be described later.

The communicator 212 is connected to the EMS 32 included in the upper control system 3 to perform communication therebetween through a communication network, and performs communication between the upper control system 3 and the controller 211. The communication network may be a wireless communication network such as a wireless LAN, a mobile network, or Bluetooth, or may be a wired communication network such as a dedicated line, an Ethernet, or a serial communication cable.

The communicator 212 may directly communicate with the power supply command center 31 not through the EMS 32.

The inputter-outputter 213 receives an instruction from a user (worker). The instruction from the user is, for example, an instruction to cancel an autonomous mode to be described later. The inputter-outputter 213 outputs information indicating the state of each element included in the inverter 21, such as the SoC value of the storage battery 214.

The storage battery 214 is a chargeable and dischargeable storage battery and stores electric power to be consumed by the consumer device 23 and the controller 211. Hereinafter, for description, the sign of the electric power value P that the storage battery 214 inputs and outputs is defined such that a discharging direction (electric power outputting) of the storage battery 214 is “+” and a charging direction (electric power inputting) of the storage battery 214 is “−”. The discharging direction of the storage battery 214 is the direction of outputting from the inverter 21 to the microgrid 2M. The charging direction of the storage battery 214 is the direction of inputting from the microgrid 2M to the inverter 21. The positive and negative definitions may be opposite.

The DC/DC converter 215 performs DC-DC conversion of DC voltage of DC power supplied from the storage battery 214.

The DC/AC inverter 216 converts, into AC power that is usable by the consumer device 23, DC power supplied from the storage battery 214 and subjected to DC-DC conversion through the DC/DC converter 215.

The current sensor 217 detects current of the microgrid 2M (current at an output end of the inverter 21) and outputs information indicating the detected current to the controller 211.

The voltage sensor 218 detects voltage of the microgrid 2M (voltage at the output end of the inverter 21) and outputs information indicating the detected voltage to the controller 211.

The renewable energy electric generator 219 is an electric power supply device configured to generate electric power to be consumed by the consumer device 23 and the controller 211. The renewable energy electric generator 219 may supply electric power to the storage battery 214. The renewable energy electric generator 219 generates variable renewable energy. The renewable energy electric generator 219 is, for example, a solar power generator.

### Exemplary Operation of Controller 211

Operation performed by the controller 211 will be described below with reference to the accompanying drawings. In a normal state, the controller 211 controls the electric power value P of the storage battery 214 in accordance with a command (the electric power command value P_{command}) from the upper control system 3. The “normal state” is a state in which communication between the upper control system 3 and the communicator 212 is maintained and the switch 22 is closed.

In an emergency state, the controller 211 makes a transition to the “autonomous mode” in which the controller 211 autonomously controls the electric power value P of the storage battery 214 based on the charge remaining amount of the storage battery 214. In the present embodiment, the SoC is used as the charge remaining amount, but another value or indicator such as the amount of electric charge accumulated in the storage battery 214 may be used. The “emergency state” is a state in which at least one of a case where the controller 211 determines that communication between the upper control system 3 and the communicator 212 fails (communication failure has occurred) and a case where the switch 22 is opened is satisfied.

Communication failure occurs when at least one of the upper control system 3, the communicator 212, and the communication network between the upper control system 3 and the communicator 212 does not normally operate. For example, a signal is regularly (periodically) transmitted from the upper control system 3 to the communicator 212, and the controller 211 determines that communication failure has occurred when the periodic signal cannot be received by the communicator 212. Alternatively, communication check such as periodic transmission of an echo request from the communicator 212 to the upper control system 3 is performed, and the controller 211 determines that communication failure has occurred when a response such as an acknowledgement (ACK) signal cannot be received from the upper control system in an allowed time.

As described above, the switch 22 is opened when anomaly such as an accident has occurred to the electric power system 2 or when work is performed. When the switch 22 is opened, the microgrid 2M is electrically separated (disconnected) form the electric power system 2.

In any case, when having sensed the emergency state, the controller 211 makes a transition to the autonomous mode. After transition to the autonomous mode, the controller 211 controls the inverter 21 until the electric power system 1 recovers to the normal state. Alternatively, for example, when there is any other effective control method than control by the controller 211, the autonomous mode may be manually canceled by the user through the inputter-outputter 213.

When the switch 22 is closed, the controller 211 may determine that the electric power system 1 has recovered once communication between the upper control system 3 and the communicator 212 is resumed, and may cancel the autonomous mode. Alternatively, when the switch 22 is closed, the controller 211 may determine that the electric power system 1 has recovered once the communicator 212 receives a command from the upper control system 3, and may cancel the autonomous mode.

Operation of the controller 211 in the autonomous mode will be described below with reference to the accompanying drawings.

Electric power is described in a pu (per unit) method normalized with rated electric power of the storage battery 214. The storage battery 214 has a capacity of 20 kWh, a rated electric power (1 pu) of 20 kW, and a system frequency of 50 Hz. Hereinafter, “SoC” means the SoC (State of charge) of the storage battery 214.

### Charging

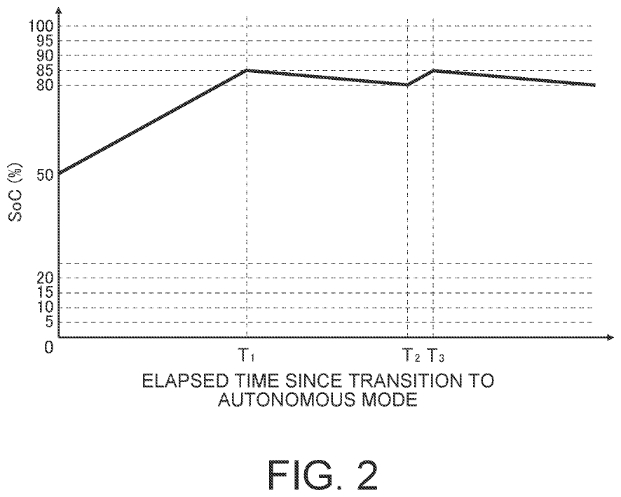

First, in the normal state, a command with the electric power command value P_{command} of −20 KW (specifically, charging at 20 kW per hour) is output from the upper control system 3, and the storage battery 214 is charged at the electric power value P=−20 kW. Then, as illustrated in FIG. 2, transition to the emergency state occurs at a time point of SoC=50% (t=0).

In this case, without any measures, the storage battery 214 continues charging at 20 KW per hour in accordance with the command from the upper control system 3 in the normal state after transition to the emergency state, and accordingly, approaches or reaches SoC=100% in 0.5 hours.

Thus, as illustrated in FIG. 2, at a time point (t=T₁) at which the SoC reaches a first threshold value (for example, 85%), the controller 211 performs control that electric power inputting (charging) to the storage battery 214 stops, in other words, the electric power value P of the storage battery 214 becomes 0 pu (0 KW) (first operation).

Thereafter, the electric power value P of the storage battery 214 is 0 pu, but the SoC gradually decreases due to standby electric power (t=T₁ to T₂).

As the stop of electric power inputting to the storage battery 214 continues (the electric power value P is continuously 0 pu), the SoC eventually approaches or reaches 0% due to standby electric power. Thus, when the SoC reaches a second threshold value (for example, 80%) (t=T₂), the controller 211 charges the storage battery 214 (second operation). The second threshold value is lower than the first threshold value.

During the charging, the storage battery 214 is charged at a certain electric power value P (t=T₂ to T₃). For example, the storage battery 214 may be charged at the electric power value P in the normal state (specifically, the same electric power value as P at t=0 to T₁) or may be charged at an optional electric power value P. When the SoC reaches the first threshold value again through the charging, the controller 211 stops electric power inputting to the storage battery 214 (charging) again, in other words, sets the electric power value P of the storage battery 214 to zero (0 pu) again (first operation).

As described above, after the SoC reaches the first threshold value, the first operation and the second operation are alternately repeated so that the value of the SoC stays between the first threshold value and the second threshold value, and accordingly, it is possible to prevent the SoC from approaching or reaching 100%.

### Discharging

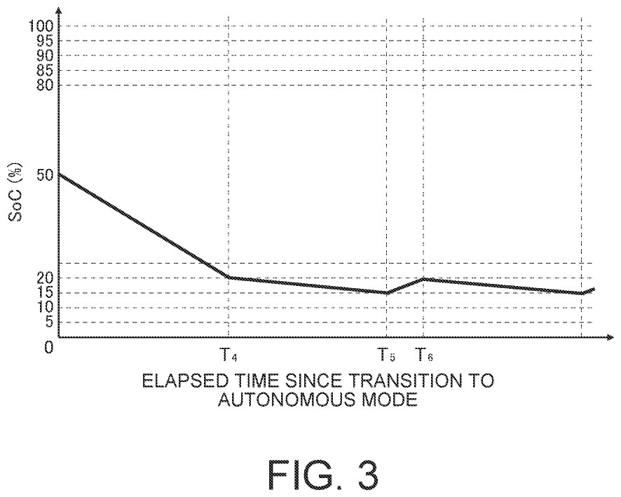

At discharging as well, the same control as at charging is possible by appropriately setting the first threshold value and the second threshold value. As illustrated in FIG. 3, at discharging, transition to the emergency state occurs at the SoC=50% (t=0).

When the SoC reaches a first threshold value (for example, 20%) (t=T₄), the controller 211 performs control that electric power outputting (discharging) from the storage battery 214 stops, in other words, the electric power value P of the storage battery 214 becomes 0 pu (first operation).

Thereafter, the electric power value P of the storage battery 214 is 0 pu, but the SoC gradually decreases due to standby electric power (t=T₄ to T₅).

Irrespective of continuation of the stop of electric power outputting from the storage battery 214, the SoC eventually approaches or reaches 0% due to standby electric power. Thus, when the SoC reaches a second threshold value (for example, 15%) (t=T₅), the controller 211 charges the storage battery 214 (second operation).

During the charging, the storage battery 214 is charged at an optional electric power value P (t=T₅ to T₆). When the SoC reaches the first threshold value again through the charging, the controller 211 stops electric power outputting from the storage battery 214 again, in other words, sets the electric power value P of the storage battery 214 to 0 pu again (the first operation).

As described above, at discharging as well, after the SoC reaches the first threshold value, the first operation and the second operation are alternately repeated so that the value of the SoC stays between the first threshold value and the second threshold value, and accordingly, it is possible to prevent the SoC from approaching or reaching 0%.

Thus, at charging and discharging in the autonomous mode, the controller 211 performs the first operation that stops electric power inputting and outputting of the storage battery 214 when the SoC reaches a first threshold value. After the first operation, when the SoC decreases due to standby electric power and reaches a second threshold value, the controller 211 performs the second operation that charges the storage battery 214.

In the above description, the electric power value P is controlled based on the SoC, but the electric power value P may be controlled based on elapsed time since transition to the autonomous mode. For example, at discharging, the first operation and the second operation may be alternately repeated each time a predetermined time elapses, for example, the first operation is performed at t=T₁, the second operation is performed at t=T₂, the first operation is performed at t=T₃, . . . (refer to FIG. 2).

### Flowchart

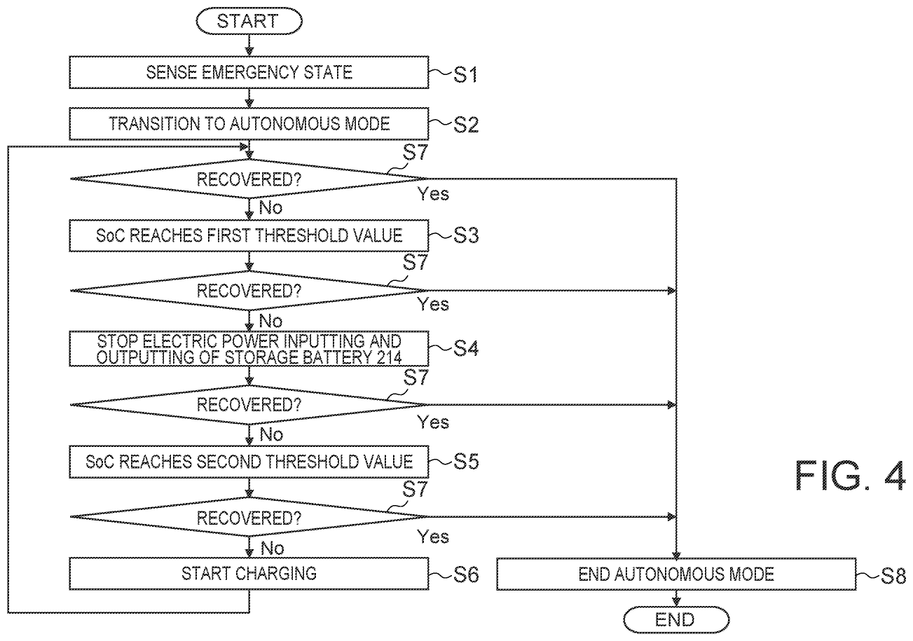

FIG. 4 is a flowchart for description of operation of the inverter 21.

First, the controller 211 senses the emergency state (step S1). Having sensed the emergency state, the controller 211 makes a transition to the autonomous mode (step S2).

Subsequently, the SoC of the storage battery 214 reaches a first threshold value (step S3). When having sensed that the SoC reaches the first threshold value, the controller 211 stops electric power inputting and outputting of the storage battery 214 (step S4).

Subsequently, the SoC of the storage battery 214 reaches a second threshold value due to standby electric power (step S5). When having sensed that the SoC reaches the second threshold value, the controller 211 starts charging the storage battery 214 (step S6). Thereafter, the controller 211 returns to step S3.

After the transition to the autonomous mode, the controller 211 determines as needed whether the normal state is recovered (step S7). Steps S3 to S6 are repeated until the controller 211 determines that the normal state is recovered (No at step S7).

When having determined that the normal state is recovered at any timing after the transition to the autonomous mode (Yes at step S7), the controller 211 ends (cancels) the autonomous mode (step S8). After the end of the autonomous mode, the storage battery 214 is controlled based on a command from the upper control system 3.

In a case where the SoC already reaches the first threshold value at the time point (step S2) when the controller 211 makes a transition to the autonomous mode, the controller 211 may immediately stop electric power inputting and outputting of the storage battery 214.

In a case where the storage battery 214 is discharging and the SoC is equal to or lower than the second threshold value at the time point (step S2) when the controller 211 makes a transition to the autonomous mode, the controller 211 may immediately charge the storage battery 214.

As described above, it is possible to prevent the SoC from approaching or reaching 100% or 0% by controlling the SoC of the storage battery 214 between two threshold values. Moreover, since the two threshold values of first and second threshold values for switching operation are prepared to provide hysteresis to the threshold values, it is not needed to frequently switch operation when the SoC varies due to noise or the like, and thus it is possible to simplify control.

When the electric generator 24 and the inverter 21 (the storage battery 214 and the inverter 216) in the microgrid 2M have droop characteristics, the SoC of the storage battery 214 potentially varies irrespective of control by the controller 211 in the emergency state.

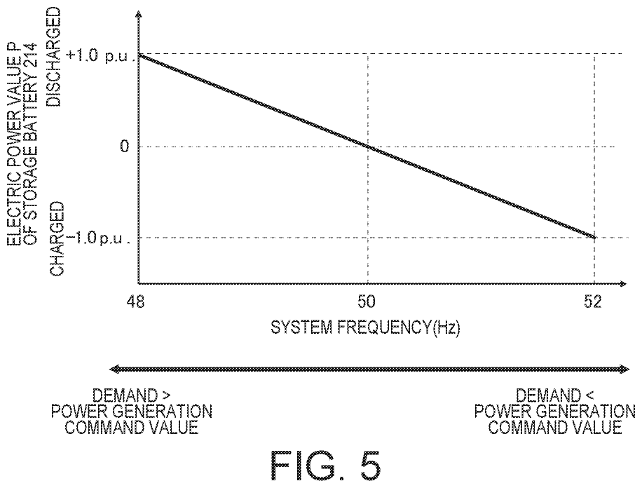

The droop characteristics of the electric generator 24 and the inverter 21 of the microgrid 2M will be described below. FIG. 5 illustrates an example of the droop characteristics of the electric generator 24 and the inverter 21 of the microgrid 2M. More specifically, FIG. 5 illustrates the droop characteristics of a governor (a speed regulator) included in the synchronous electric generator 241 in the microgrid 2M and the behavior of the storage battery 214 due to the droop characteristics.

In the microgrid 2M, supply-demand balance of electric power is desirably maintained constant. The microgrid 2M can stabilize supply-demand balance of electric power in the microgrid 2M by adjusting the frequency (system frequency) of the synchronous electric generator 241 to a reference frequency (for example, 50 Hz) as much as possible. For this reason, droop characteristics are provided to the electric generator 24 and the inverter 21 of the microgrid 2M.

For example, in the normal state, the upper control system 3 outputs a command with a power generation command value of 1 pu to achieve an electric power value P_{supply}=1 pu at which the synchronous electric generator 241 generates (supplies) power at the reference frequency (50 Hz).

When the power generation command value to the synchronous electric generator 241 is insufficient for the amount of power consumption (demand) in the microgrid 2M (power generation command value<demand), the system frequency of the synchronous electric generator 241 is lower than 50 kHz due to droop characteristics. As illustrated in FIG. 5, when the system frequency is lower than 50 kHz, the storage battery 214 is controlled to discharge to compensate insufficient supply.

When the power generation command value to the synchronous electric generator 241 is excessive for the amount of consumption (demand) (power generation command value>demand), the system frequency of the synchronous electric generator 241 exceeds 50 kHz due to droop characteristics. As illustrated in FIG. 5, when the system frequency exceeds 50 kHz, the storage battery 214 is controlled to charge to prevent excessive supply.

When the power generation command value to the synchronous electric generator 241 is equivalent to the amount of consumption (demand) (power generation command value=demand), the system frequency of the synchronous electric generator 241 becomes 50 Hz due to droop characteristics. As illustrated in FIG. 5, when the system frequency is 50 kHz, electric power generated by the synchronous electric generator 241 is consumed in the microgrid 2M without overage nor shortage. Thus, the storage battery 214 does not need to discharge nor charge and is controlled to stop inputting and outputting (so that the electric power value P is 0 pu).

As described above, when the inverter 21 in the microgrid 2M has droop characteristics, adjustment is made to stabilize supply-demand balance of electric power in the microgrid 2M. However, in the emergency state, the storage battery 214 potentially approaches or reaches a fully charged state or a completely discharged state due to droop characteristics irrespective of control by the controller 211. Thus, the controller 211 may disable the droop characteristics of a governor included in the inverter 21 at an optional timing, for example, at a time point when the SoC becomes larger or smaller than a predetermined threshold value, in other words, when the SoC becomes out of a predetermined range. Alternatively, the controller 211 may disable the droop characteristics of the governor included in the inverter 21 at the time point of transition to the autonomous mode.

Alternatively, the synchronous electric generator 241 may include a governor with isochronous characteristics and a governor with droop characteristics. When the synchronous electric generator 241 operates by using the governor with isochronous characteristics, the rotational speed of the synchronous electric generator 241 is controlled to be constant irrespective of a load (demand electric power) connected to the synchronous electric generator 241. Then, when the SoC is larger or smaller than a predetermined threshold value or when transition to the autonomous mode has occurred, the controller 211 may switch the governor included in the synchronous electric generator 241 to the governor with isochronous characteristics.

Similarly, for example, when the inverter 21 includes the renewable energy electric generator 219 and/or when the electric generator 24 includes the renewable energy electric generator 242, the renewable energy electric generator 219 and/or the renewable energy electric generator 242 may have pseudo inertial force. For example, when electric power demand in the microgrid 2M has changed, the controller 211 controls the storage battery 214 to charge or discharge electric power in an amount in accordance with the change of the electric power demand, in other words, provides pseudo inertial force to an output from the storage battery 214. The controller 211 may provide pseudo inertial force to an output from the renewable energy electric generator 219. Accordingly, supply-demand balance in the microgrid 2M is stabilized.

However, in the emergency state, the storage battery 214 potentially approaches or reaches the fully charged state or the completely discharged state due to pseudo inertial force of the renewable energy electric generator 219 irrespective of control by the controller 211. Thus, the controller 211 may disable pseudo inertial force of the renewable energy electric generator 219 at an optional timing (for example, a time point when the SoC becomes larger or smaller than a predetermined threshold value or a time point when transition to the autonomous mode occurs).

### Other Exemplary Operations

Inputting and outputting of the storage battery 214 may be stopped by gradually reducing the electric power value P of the storage battery 214, in other words, changing the electric power value P of the storage battery 214 closer to 0 pu in accordance with the SoC of the storage battery 214 or in accordance with elapsed time since transition to the autonomous mode. Accordingly, it is possible to avoid abrupt change of electric power balance in the microgrid 2M, thereby reducing a load applied to the microgrid 2M (in particular, the consumer device 23 and/or the electric generator 24).

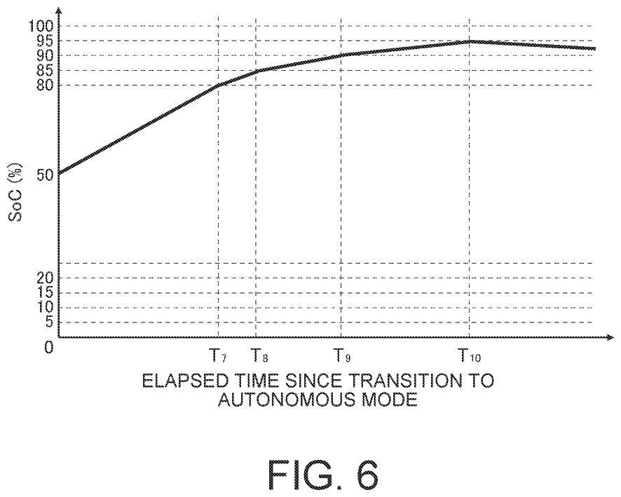

For example, as illustrated in FIG. 6, input electric power (charging electric power) may be reduced at stages, in other words, the electric power value P may be reduced at stages. In the example illustrated in FIG. 6, the electric power value P is controlled as in (1) to (4) below.
(1) Until the SoC becomes 80% or until t=T₇, the electric power value P is held at the previous value, in other words, the value (in this example, −20 KW) of the electric power command value P_{command} received in the normal state.
(2) When the SoC reaches 80% or at t=T₇, the electric power value P is changed from −20 kW to −15 kW.
(3) When the SoC reaches 85% or at t=T₈, the electric power value P is changed to −10 kW.
(4) When the SoC reaches 90% or at t=T₉, the electric power value P is changed to −5 kW.
(5) When the SoC reaches 95% or at t=T₁₀, the electric power value P is changed to 0 kW.

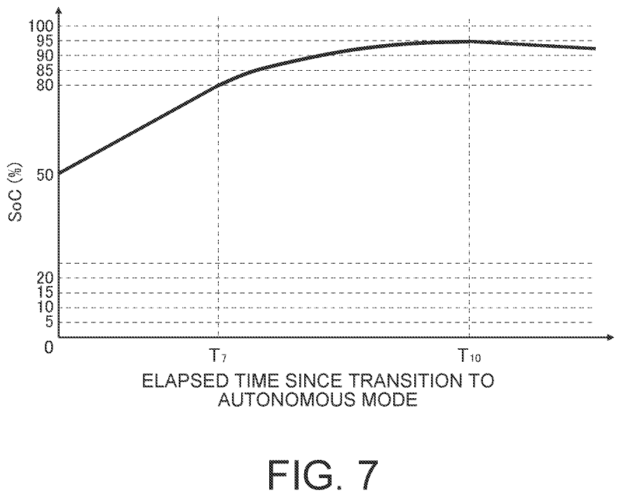

Alternatively, as illustrated in FIG. 7, the electric power value P of the storage battery 214 may be continuously reduced in accordance with the SoC of the storage battery 214 or in accordance with elapsed time since transition to the autonomous mode. Specifically, the absolute value of the electric power value P may be reduced as the SoC is larger or as elapsed time since transition to the autonomous mode is longer.

As described above, the electric power value P of the storage battery 214 is reduced at stages or continuously to stop inputting and outputting of the storage battery 214. Thereafter, the first operation and the second operation may be alternately repeated between optional first and second threshold values.

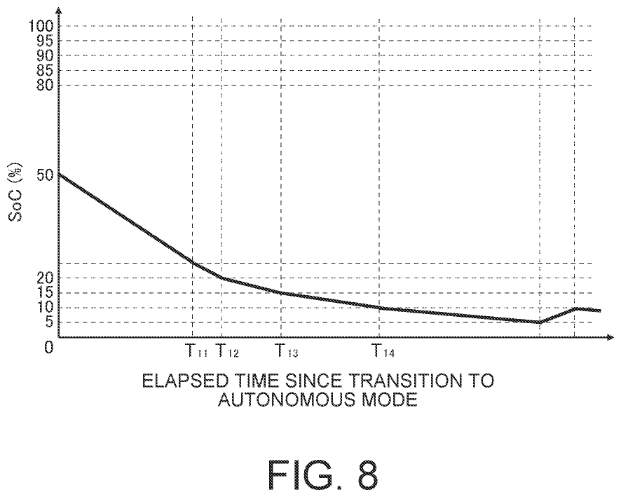

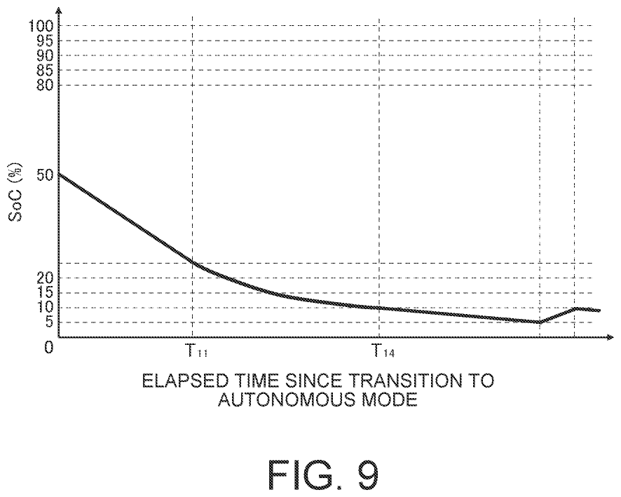

Similarly for discharging, as illustrated in FIG. 8 or 9, output electric power (discharging electric power) is reduced at stages or continuously, in other words, the electric power value P is reduced at stages or continuously. Specifically, the absolute value of the electric power value P may be reduced as the SoC is smaller or as elapsed time since transition to the autonomous mode is longer. Thereafter, the first operation and the second operation may be alternately repeated between optional first and second threshold values.

In this manner, it is possible to avoid abrupt change of electric power balance in the microgrid 2M by gradually reducing the electric power value P in accordance with the SoC or time to stop inputting and outputting of the storage battery 214.

As described above, according to the present embodiment, it is possible to prevent the SoC of the storage battery 214 from approaching or reaching 0% or 100% in the emergency state. Accordingly, it is possible to prevent failure of the storage battery 214. Moreover, since a certain amount of electric power is constantly charged in the storage battery 214, electric power for operating the controller 211 is constantly ensured, and thus it is possible to immediately recover to the normal state.

### Hardware Configuration

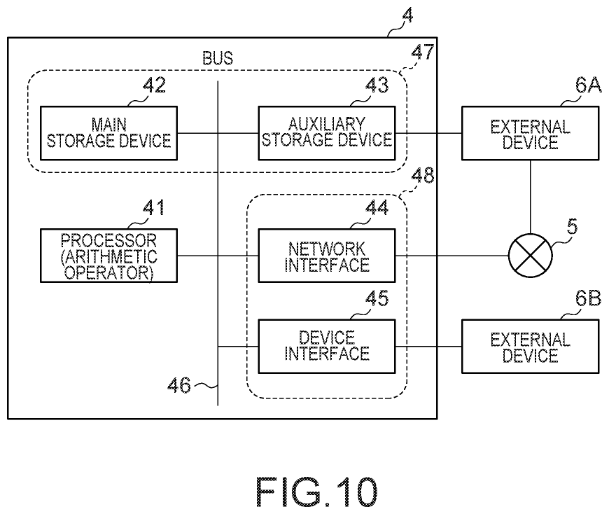

FIG. 10 is a block diagram illustrating an example of a hardware configuration of the controller 211 according to the embodiment of the present invention. The controller 211 can be implemented as a computer device 4 including a processor (arithmetic operator) 41, a main storage device 42, an auxiliary storage device 43, a network interface 44, and a device interface 45 that are connected to one another through a bus 46.

The computer device 4 in FIG. 10 includes one constituent component of each kind but may include a plurality of constituent components of each kind. Although one computer device 4 is illustrated in FIG. 10, software may be installed on a plurality of computer devices and processing of different parts of the software may be executed by the respective computer devices.

The processor 41 performs arithmetic processing based on data or a computer program input from an internal component of the computer device 4 or the like and outputs a processing result or a control signal to a device or the like. Specifically, the processor 41 controls each device included in the computer device 4 by executing the operating system (OS) of the computer device 4, applications, and the like. The processor 41 is not particularly limited as long as the processor 41 can perform the above-described processing. Main processing of the controller 211 is performed by the processor 41.

The main storage device 42 is a storage device configured to store, for example, commands executed by the processor 41 and various kinds of data. Information stored in the main storage device 42 is directly read by the processor 41. The auxiliary storage device 43 is a storage device other than the main storage device 42. At least one of the main storage device 42 and the auxiliary storage device 43 may be treated as a storage 47. When parameters related to the way that droop characteristics change and functions that represent droop characteristics are prepared in advance, the functions can be stored in the storage 47. These storage devices mean optional electronic components capable of storing electronic information and may be memories or storages. The memories may be transitory memories or non-transitory memories.

The network interface 44 and the device interface 45 are included in a communicator 48 that is a constituent component for communicating with devices (external devices 6A and 6B) different from the computer device 4. At least one of the network interface 44 and the device interface 45 may be treated as the communicator 212. Communication with the external devices 6A and 6B can be performed by the communicator 48.

The network interface 44 is an interface for connecting to a communication network 5 through wireless or wired communication. The network interface 44 may be one that is compliant with an existing communication standard. With the network interface 44, information may be communicated with the external device 6A connected for communication through the communication network 5.

The device interface 45 is an interface such as a USB that is directly connected to the external device 6B. The external device 6B may be an external storage medium or may be a storage device such as a database.

The external devices 6A and 6B may be output devices. The output devices may be, for example, display devices for displaying images, or devices for outputting voice or the like. The output devices are, for example, a liquid crystal display (LCD), a cathode ray tube (CRT), a plasma display panel (PDP), and a speaker, but not limited thereto.

The external devices 6A and 6B may be input devices. The input devices include devices such as a keyboard, a mouse, and a touch panel and provide information input through these devices to the computer device 4. Signals from the input devices are output to the processor 41.

While certain embodiment have been described, these embodiment have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### CLAUSES

Clause 1. An electric power system comprising:
an electrical storage device electrically connected to an electric power system; and
a controller configured to
   control the electrical storage device based on an electric power command from an upper control system configured to control input-output electric power of the electrical storage device, and
   make a transition to an autonomous mode in which the input-output electric power of the electrical storage device is controlled based on a charge remaining amount of the electrical storage device, in at least one of a case where the controller senses that communication with the upper control system fails or a case where the controller senses that the electrical storage device and the electric power system is disconnected.
      Clause 2. The electric power system according to Clause 1, wherein
when the charge remaining amount becomes a first threshold value in the autonomous mode, the controller performs first operation that stops inputting and outputting of electric power of the electrical storage device, and
when the charge remaining amount becomes a second threshold value due to standby electric power consumption after the first operation, the controller performs second operation that charges the electrical storage device.
   Clause 3. The electric power system according to Clause 1 or 2, wherein the controller stops inputting of electric power of the electrical storage device by reducing input electric power of the electrical storage device at stages or continuously in accordance with the charge remaining amount of the electrical storage device in the autonomous mode or the controller stops outputting of electric power of the electrical storage device by reducing output electric power of the electrical storage device at stages or continuously in accordance with the charge remaining amount of the electrical storage device in the autonomous mode.
   Clause 4. The electric power system according to Clause 1 or 2, wherein the controller stops inputting of electric power of the electrical storage device by reducing input electric power of the electrical storage device at stages or continuously in accordance with an elapsed time of the autonomous mode in the autonomous mode or the controller stops outputting of electric power of the electrical storage device by reducing output electric power of the electrical storage device at stages or continuously in accordance with an elapsed time of the autonomous mode in the autonomous mode.
   Clause 5. The electric power system according to any one of Clauses 1 to 4, further comprising an electronic device including
the controller, and
an inverter configured to convert DC power supplied from the electrical storage device into AC power,
wherein droop characteristics of the electronic device is disabled when the charge remaining amount of the electrical storage device is out of a predetermined range after transition to the autonomous mode.
   Clause 6. The electric power system according to any one of Clauses 1 to 5, further comprising an electronic device including
the controller, and
an electric power supply device configured to supply electric power to the electrical storage device, wherein
the controller provides pseudo inertial force to an output from the electric power supply device, and
the controller disables the pseudo inertial force after transition to the autonomous mode.
   Clause 7. The electric power system according to any one of Clauses 1 to 6, further comprising an electronic device including
the controller, and
a communicator configured to perform communication between the upper control system and the controller, wherein
the electronic device periodically sends a request to the upper control system, and
the controller makes a transition to the autonomous mode when the electronic device does not receive a response from the upper control system in an allowed time.
   Clause 8. The electric power system according to any one of Clauses 1 to 7, wherein the controller cancels the autonomous mode when having determined that communication with the upper control system is resumed in a state which the electrical storage device and the electric power system is connected.
   Clause 9. The electric power system according to any one of Clauses 1 to 7, wherein the controller cancels the autonomous mode when communication with the upper control system is resumed and a command related to control of the electrical storage device is received from the upper control system in a state which the electrical storage device and the electric power system is connected.
   Clause 10. The electric power system according to any one of Clauses 1 to 9, wherein the charge remaining amount is SoC.
   Clause 11. An electronic device comprising a controller configured to
control an electrical storage device electrically connected to an electric power system based on an electric power command from an upper control system configured to control input-output electric power of the electrical storage device, and
make a transition to an autonomous mode in which input-output electric power of the electrical storage device is controlled based on a charge remaining amount of the electrical storage device, inn at least one of a case where the controller senses that communication with the upper control system fails and a case where the controller senses that the electrical storage device and the electric power system is disconnected.
   Clause 12. An electric control method comprising:
controlling an electrical storage device electrically connected to an electric power system, based on an electric power command from an upper control system configured to control input-output electric power of the electrical storage device; and
making a transition to an autonomous mode in which the input-output electric power of the electrical storage device is controlled based on a charge remaining amount of the electrical storage device, in at least one of a case of sensing that communication with the upper control system fails or a case of sensing that the electrical storage device and the electric power system is disconnected.
   Clause 13. A non-transitory computer readable medium having a computer program stored therein which causes a computer to execute processes comprising:
controlling an electrical storage device electrically connected to an electric power system, based on an electric power command from an upper control system configured to control input-output electric power of the electrical storage device; and
making a transition to an autonomous mode in which the input-output electric power of the electrical storage device is controlled based on a charge remaining amount of the electrical storage device, in at least one of a case of sensing that communication with the upper control system fails or a case of sensing that the electrical storage device and the electric power system is disconnected.

1. An electric power system comprising:
an electrical storage device electrically connected to an electric power system; and
a controller configured to
control the electrical storage device based on an electric power command from an upper control system configured to control input-output electric power of the electrical storage device, and
make a transition to an autonomous mode in which the input-output electric power of the electrical storage device is controlled based on a charge remaining amount of the electrical storage device, in at least one of a case where the controller senses that communication with the upper control system fails or a case where the controller senses that the electrical storage device and the electric power system is disconnected.

2. The electric power system according to claim 1, wherein
when the charge remaining amount becomes a first threshold value in the autonomous mode, the controller performs first operation that stops inputting and outputting of electric power of the electrical storage device, and
when the charge remaining amount becomes a second threshold value due to standby electric power consumption after the first operation, the controller performs second operation that charges the electrical storage device.

3. The electric power system according to claim 1, wherein the controller stops inputting of electric power of the electrical storage device by reducing input electric power of the electrical storage device at stages or continuously in accordance with the charge remaining amount of the electrical storage device in the autonomous mode or the controller stops outputting of electric power of the electrical storage device by reducing output electric power of the electrical storage device at stages or continuously in accordance with the charge remaining amount of the electrical storage device in the autonomous mode.

4. The electric power system according to claim 1, wherein the controller stops inputting of electric power of the electrical storage device by reducing input electric power of the electrical storage device at stages or continuously in accordance with an elapsed time of the autonomous mode in the autonomous mode or the controller stops outputting of electric power of the electrical storage device by reducing output electric power of the electrical storage device at stages or continuously in accordance with an elapsed time of the autonomous mode in the autonomous mode.

5. The electric power system according to claim 1, further comprising an electronic device including
the controller, and
an inverter configured to convert DC power supplied from the electrical storage device into AC power,
wherein droop characteristics of the electronic device is disabled when the charge remaining amount of the electrical storage device is out of a predetermined range after transition to the autonomous mode.

6. The electric power system according to claim 1, further comprising an electronic device including
the controller, and
an electric power supply device configured to supply electric power to the electrical storage device, wherein
the controller provides pseudo inertial force to an output from the electric power supply device, and
the controller disables the pseudo inertial force after transition to the autonomous mode.

7. The electric power system according to claim 1, further comprising an electronic device including
the controller, and
a communicator configured to perform communication between the upper control system and the controller, wherein
the electronic device periodically sends a request to the upper control system, and
the controller makes a transition to the autonomous mode when the electronic device does not receive a response from the upper control system in an allowed time.

8. The electric power system according to claim 1, wherein the controller cancels the autonomous mode when having determined that communication with the upper control system is resumed in a state which the electrical storage device and the electric power system is connected.

9. The electric power system according to claim 1, wherein the controller cancels the autonomous mode when communication with the upper control system is resumed and a command related to control of the electrical storage device is received from the upper control system in a state which the electrical storage device and the electric power system is connected.

10. The electric power system according to claim 1, wherein the charge remaining amount is SoC.

11. An electronic device comprising a controller configured to
control an electrical storage device electrically connected to an electric power system based on an electric power command from an upper control system configured to control input-output electric power of the electrical storage device, and
make a transition to an autonomous mode in which input-output electric power of the electrical storage device is controlled based on a charge remaining amount of the electrical storage device, inn at least one of a case where the controller senses that communication with the upper control system fails and a case where the controller senses that the electrical storage device and the electric power system is disconnected.

12. An electric control method comprising:
controlling an electrical storage device electrically connected to an electric power system, based on an electric power command from an upper control system configured to control input-output electric power of the electrical storage device; and
making a transition to an autonomous mode in which the input-output electric power of the electrical storage device is controlled based on a charge remaining amount of the electrical storage device, in at least one of a case of sensing that communication with the upper control system fails or a case of sensing that the electrical storage device and the electric power system is disconnected.

13. A non-transitory computer readable medium having a computer program stored therein which causes a computer to execute processes comprising:
controlling an electrical storage device electrically connected to an electric power system, based on an electric power command from an upper control system configured to control input-output electric power of the electrical storage device; and
making a transition to an autonomous mode in which the input-output electric power of the electrical storage device is controlled based on a charge remaining amount of the electrical storage device, in at least one of a case of sensing that communication with the upper control system fails or a case of sensing that the electrical storage device and the electric power system is disconnected.
